(19) United States
(12) Patent Application Publication
(10) Pub. No.: US 2012/0294110 A1
(43) Pub. Date: Nov. 22, 2012

(54) MIXER FOR MIXING CONTENTS OF PAINT POT

(76) Inventor: Pentti Airaksinen, Oulu (FI)

(21) Appl. No.: 13/510,637

(22) PCT Filed: Nov. 19, 2010
(86) PCT No.: PCT/FI10/50937

§ 371 Date: Jul. 30, 2012

(30) Foreign Application Priority Data
Nov. 20, 2009 (FI) 20096211

(51) Int. Cl. B01F 9/00

(52) U.S. Cl. 366/213

(57) ABSTRACT

The invention relates to a mixer for mixing the contents of a paint pot, the mixer comprising pressing means (5 to 8, 12) for pressing the paint pot (1) in the direction of its longitudinal axis between two support surfaces (5, 6), and means (12) for rotating the paint pot pressed between these support surfaces about its longitudinal axis and a shaft (2) substantially perpendicular to the longitudinal axis, whereby the pressing means and the rotating means are combined to form a mechanism (5 to 8, 12) arranged to be operated by one drive.

### BACKGROUND OF THE INVENTION

The invention relates to a mixer for mixing the contents of a paint pot, the mixer comprising pressing means for pressing the paint pot in the direction of its longitudinal axis between two support surfaces, and means for rotating the paint pot pressed between these support surfaces about its longitudinal axis and a shaft substantially perpendicular to the longitudinal axis.

This type of gyroscopic mixer has long been used for mixing contents of paint pots. At present, it is the best known and most effective mixer on the market. It has been manufactured since the 1920's and used for mixing different liquids with one another in a cylindrical pot. Today, known mixers are mostly constructed in such a manner that they comprise an upper plate and a lower plate, between which a paint pot is pressed. The pressing is carried out by a separate motion, most commonly by a screw arrangement, with which the plates are made to move towards one another. There are also apparatuses that perform the pressing manually or hydraulically. All of these are quite complicated and in some cases very slow. In automatic devices, for example, it has been detected that automatically pressing plates provided with a separate engine slow down the process and cause delays of up to 20% in mixing times. In automation, however, equipment investments are based on speed.

### SUMMARY OF THE INVENTION

It is an object of the present invention to improve the gyroscopic paint mixer so as to solve the above-mentioned problems. This object is achieved by a mixer of the invention, which is mainly characterized in that the pressing means and the rotating means are combined to form a mechanism arranged to be operated by one drive.

There is now provided a mixer, which differs essentially from the previous one in that a high-powered and fast drive engine may be connected with simple arrangements to provide the pressing of a pot whose contents are to be mixed in its place and the subsequent gyroscopic mixing of the pot. These procedures can now be performed rapidly even if the pots were heavy. When the speed of the drive engine is adjustable, the mixing can be performed efficiently for both small and large pots. When the same adjustable engine is used for lifting the pot and tightening it in its place, the entire system can easily be made automatically adjustable without separate control equipment.

Preferably the support surfaces for a paint pot consist of two plates arranged to move towards one another and connected with tightening arms which are directed towards one another and between which a drive wheel in connection therewith is arranged to bring the plates closer to one another and away from one another, the drive wheel being connected to said common drive.

Alternatively, a drive wheel is connected between the plates on the side thereof, a sheave rotating about a shaft parallel to the shaft of the drive wheel and provided in line with the drive wheel is arranged above or below one plate, the drive wheel and the sheave are connected to one another by a chain, a section of the chain between the drive wheel and the sheave and moving in one direction is connected to one plate and a section moving in the other direction is connected to the arm protruding from the other plate for bringing the plates closer to and away from one another.

According to another alternative, a drive wheel is connected between the plates on one side thereof, a sheave rotating about a shaft parallel to the shaft of the drive wheel and provided in line with the drive wheel is arranged above or below one plate, the drive wheel and the sheave are connected to one another by a chain, and on the other side of the plates, i.e. on the opposite side of the entity consisting of the sheave and the chain, there is arranged an entity substantially identical and symmetrical with said entity and comprising an auxiliary drive wheel in the same axial line with the sheave, an auxiliary sheave preferably in the same axial line with the drive wheel, and an additional chain connecting them, the sheave and the auxiliary drive wheel being connected to one another by a connecting shaft, whereby the plates are provided with transverse arms, the ends of one arm being connected to chain sections moving in one direction and the ends of the other arm being connected to chain sections moving in the other direction for bringing the plates closer to and away from one another.

To provide the rotating means, the entity consisting of the pressing means is mounted on bearings to rotate about the shaft of the drive wheel and the plates are mounted on bearings to rotate about their middle axis, whereby, to press the paint pot in its place, rotation of this mechanism about the shaft of the drive wheel is prevented and, to rotate the paint pot, the prevention of rotation is released.

The solution of the invention, especially when it comprises the above symmetrical wheel-chain arrangement, preferably allows the rotatable mechanism consisting of the pressing means and the rotating means to be supported on the mixer frame at two supporting points on the opposite side of the mechanism. Thus, a rigid double-supported structure not sensitive to vibrations is achieved. The construction is also light and cost-efficient.

In this mixer, it is also very advantageous that a conveyor is arranged at the mixer frame to cooperate with the lower plate and transfer the mixed paint pot away from the mixer.

Preferred details and alternatives of the invention are disclosed in the dependent claims. They describe, for instance, advantageous means for locking the pot in its place and spring suspensions for tightening the pot in its place, which can be achieved with the basic idea of the invention, i.e. a combined pressing and rotating mechanism which can be operated by one drive. These are described in more detail in the following.

### LIST OF FIGURES

The mixer of the invention and its operation will be described with reference to the accompanying simplified and schematic drawings, in which

FIG. 1 shows a mixer at the beginning of pressing/tightening a paint pot;

FIG. 2 shows the mixer at the end of pressing/tightening the paint pot;

FIG. 3 shows a ratchet mechanism of the mixer for locking the paint pot in its place in the step of FIG. 2;

FIG. 4 shows spring suspension alternatives of the mixer when the pot is locked in its place in the step of FIG. 2;

FIG. 5 shows an actuator of a pawl affecting a ratchet wheel of FIGS. 3 and 4;

FIG. 6 shows the operation of the mixer during mixing;

FIG. 7 shows another preferred arrangement for pressing/tightening the paint pot;

FIG. 8 shows yet another preferred alternative arrangement for pressing/tightening the paint pot; and

FIGS. 9 to 11 show how the paint pot is released from the mixer.

### DETAILED DESCRIPTION OF THE INVENTION

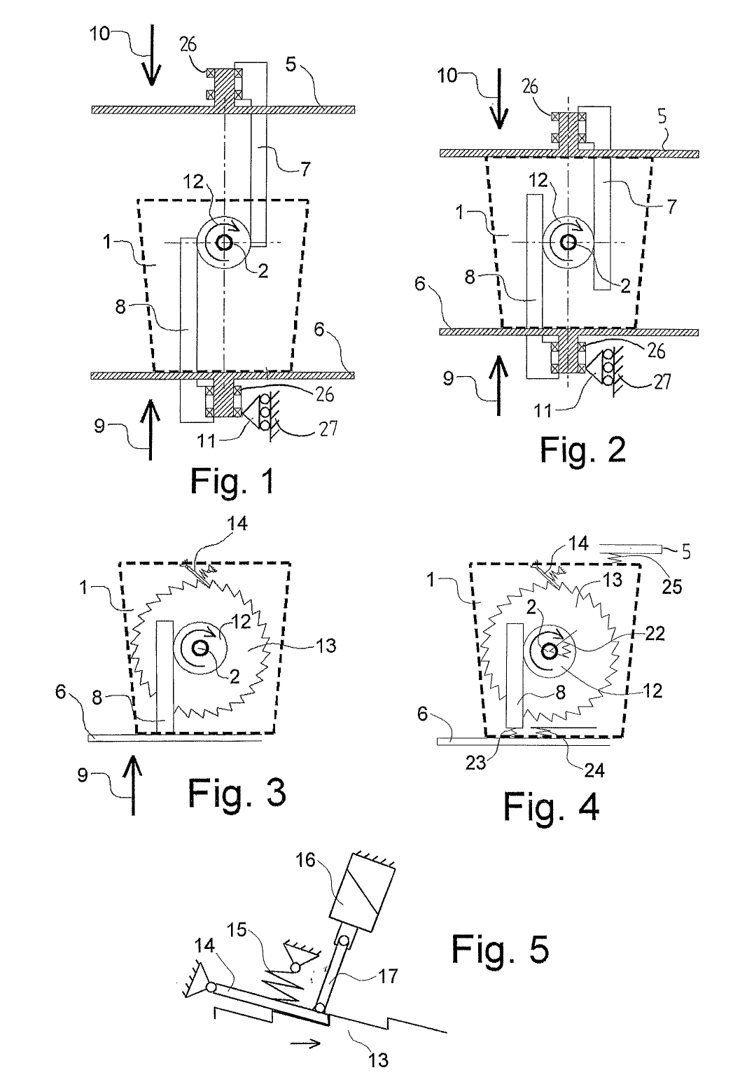

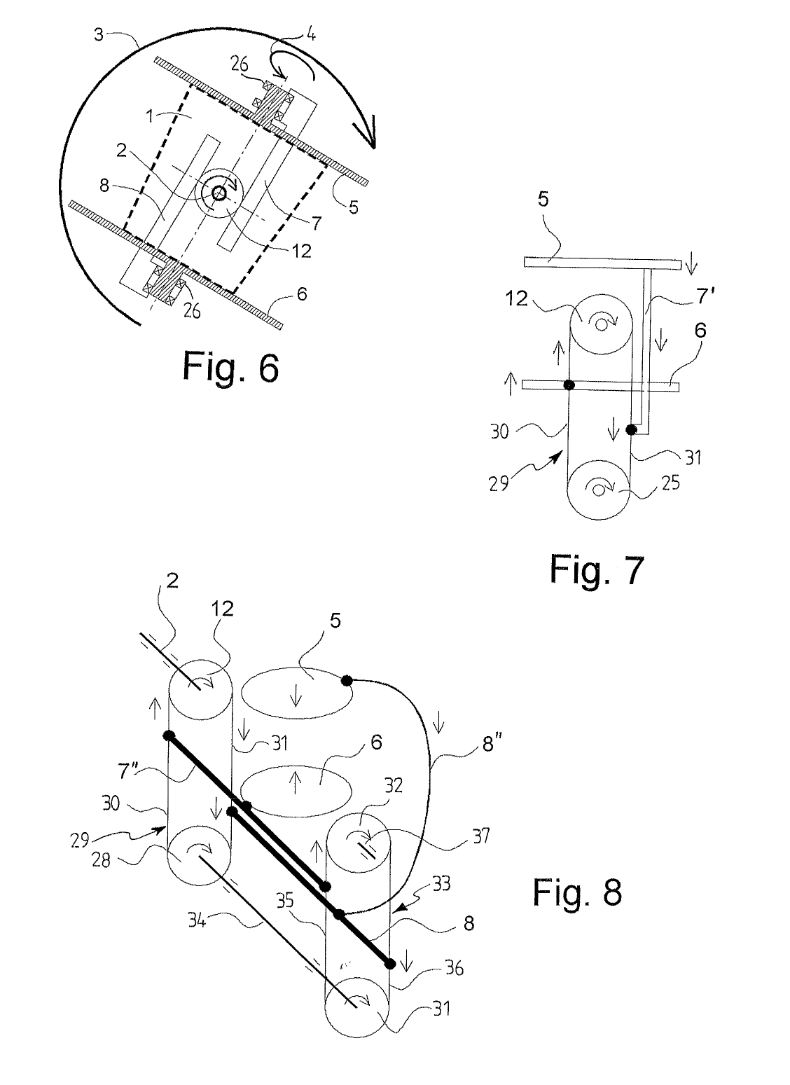

A mixer of the invention shown in the drawings, especially in FIGS. 1 to 6, and intended for mixing the contents of a paint pot comprises, as its essential parts, pressing means for pressing the paint pot 1 in the direction of its longitudinal axis between two support surfaces 5 and 6 (pressing motions 9 and 10 in FIGS. 1 and 2), and means for rotating the paint pot 1 pressed between these support surfaces 5 and 6 about its longitudinal axis and a shaft perpendicular to the longitudinal axis (rotating motions 3 and 4 in FIG. 6). The core of the structure according to the invention is that the pressing means and the rotating means are one and the same mechanism, which can therefore be operated by one single drive. This combined mechanism and its use will now be described in greater detail.

The support surfaces consist of two plates 5 and 6 arranged to move towards one another and to which tightening arms 7 and 8 directed towards the respective opposite plate 5, 6 are connected, between which tightening arms a drive wheel 12 in connection therewith is arranged together with its shaft 2 to bring the plates 5 and 6 closer to and away from one another (FIGS. 1 and 2). The drive wheel 12 is connected to a common drive, which is not shown separately herein, because the drive as such is not essential for the structure being described.

In connection with the drive wheel 12, a ratchet mechanism 13 to 17 is arranged to lock the paint pot 1 in its place between the plates (FIGS. 3 to 5). The ratchet mechanism comprises a ratchet wheel 13 coaxial with the drive wheel 12, a pawl 14 in connection with a tooth of the ratchet wheel 13, a spring 15 keeping the pawl 14 in said connection, and an actuator 16, 17 affecting the pawl 14 for releasing it from the tooth of the ratchet wheel 13. The part of the actuator marked with reference numeral 16 may be, for instance, a solenoid, motor, pneumatic cylinder or any means for pulling the pawl 14 out of the slot of the ratchet wheel 13. The actuator 16, 17 may be bifunctional to keep the pawl 14 at a desired tooth of the ratchet wheel 13 at a desired tightening torque, i.e. only in the exact tightening position that is selected despite potential accelerating torques during the actual mixing rotation after the tightening. Otherwise, if an acceleration higher than the force induced by the mass of the entire rotatable system were applied to the drive wheel 12, the paint pot 1 would be tightened even more.

An accurately adjustable tightening of paint pots 1 is essential when the paint pots 1 are of low strength and have, for instance, plastic cases, which means that no great pressing forces can be applied. When large paint pots 1 (made of tin) are needed, they have to be tightened very firmly to make them remain in their places despite pulsation caused by the Coriolis force, centrifugal force and gravity of the earth. When the drive is operated with a programmable torque, the tightness of the paint pot 1 can be adjusted to a desired value.

To adjust the tightening force applied by the plates 5 and 6 to the paint pot 1 to exactly the desired value, there may be arranged a spring suspension 22 between the ratchet wheel 13 and the drive wheel 12 and the drive shaft 2 thereof; a spring suspension 23 between the tightening arm 7, 8 and the plate 5, 6; a spring suspension 24, 25 arranged on the surface of the plate 5, 6, or a combination of thereof. By tightening the pawl 14 to the next tooth of the ratchet wheel 13, a tightening force becomes a bit greater than at the previous tooth. By selecting a sufficient density of teeth on the ratchet wheel 13 and a sufficient number of spring suspensions 22 to 25, it is in practice possible to achieve almost a continuous tightening force that is applied to the paint pot 1. The spring suspension 22 may be a pressure, draw, torsion or elastomeric spring, or a combination thereof. Similar spring solutions may also be used in connection with the spring suspension 23. The spring suspension 24, 25 of the plate 5, 6 surface may be implemented by its elastic surface material or a spring having the corresponding effect.

To provide the rotating means, the entity consisting of the above-described pressing means is mounted on bearings to rotate about the shaft 2 of the drive wheel 12 and the plates 5 and 6 are mounted on bearings to rotate about their middle axes, whereby, to press the paint pot 1 in its place, rotation of this entity about the shaft 2 of the drive wheel 12 is prevented and, to rotate the paint pot, the prevention of rotation is released. To make the plates 5 and 6 rotate, they are mounted with bearings 26 on the tightening arms 7 and 8. The rotatable entity consisting of the pressing means and the rotating means, for its part, is supported on a frame 27 of the mixer at two supporting points, which are on the opposite side of the mechanism and provided in the line formed by the shaft 2 of the drive wheel 12, or at one supporting point, i.e. preferably at the shaft of the drive wheel 12 on the side of the drive wheel 12. This support is not shown in the drawings, because it represents the general state of the art. The prevention and release of rotation are implemented in a simple manner by a connection 11 between the mixer frame 27 and the plate 5 or 6 and sliding in the axial direction of the plate 5 or 6.

Rotation of the plates 5 and 6 about the middle axes thereof is also implemented with said common drive by applying suitable cog wheel and/or belt arrangements.

FIG. 7 shows an alternative pressing arrangement, where the drive wheel 12 is connected between the plates 5 and 6 on the side thereof, the sheave 28 rotating about a shaft parallel to the shaft 2 of the drive wheel 12 and provided in line with the drive wheel 12 is arranged below the lower plate 6, the drive wheel 12 and the sheave 28 are connected to one another by a chain 29, a section 30 of the chain 29 between the drive wheel 12 and the sheave 28 and moving in one direction is connected to the lower plate 6 and a section 31 moving in the other direction is connected to an arm 7′ protruding from the upper plate 5 for bringing the plates 5 and 6 closer to and away from one another, the drive wheel 12 being also connected to said common drive.

FIG. 8 shows another alternative pressing arrangement, which is, in a way, a development of the arrangement according to FIG. 7. In this case, the drive wheel 12 is connected between the plates 5 and 6 on one side thereof, the sheave 28 rotating about a shaft parallel to the shaft 2 of the drive wheel 12 and provided in line with the drive wheel is arranged below the lower plate 6, the drive wheel 12 and the sheave 28 are connected to one another by the chain 29. All this corresponds to FIG. 7. In addition, on the other side of the plates 5 and 6, i.e. on the opposite side of the entity 12, 28 and 29 consisting of the drive wheel 12, the sheave 28 and the chain 29, there is arranged an entity substantially identical and symmetrical with said entity and comprising an auxiliary drive wheel 31 in the same axial line with the sheave 28, an auxiliary sheave 32 preferably in the same axial line with the drive wheel 12, and an additional chain 33 connecting them, the sheave 28 and the auxiliary drive wheel 31 being connected to one another by a connecting shaft 34. The lower plate 6 is in this case connected with a transverse arm 7″ and the upper plate 5 with a transverse arm 8″, the ends of the arm 7″ being connected to sections 30 and 35 of the chains 29 and 33, moving in one direction, and the ends of the arm 8″ being connected to sections 31 and 36 of the chains 29 and 33, moving in the other direction, for bringing the plates 5 and 6 closer to and away from one another, the drive wheel 12 being connected to said common drive, as in the other above-described applications.

The implementations of FIGS. 7 and 8 may be provided with similar ratchet mechanisms and spring suspensions as the implementations of FIGS. 1 to 5.

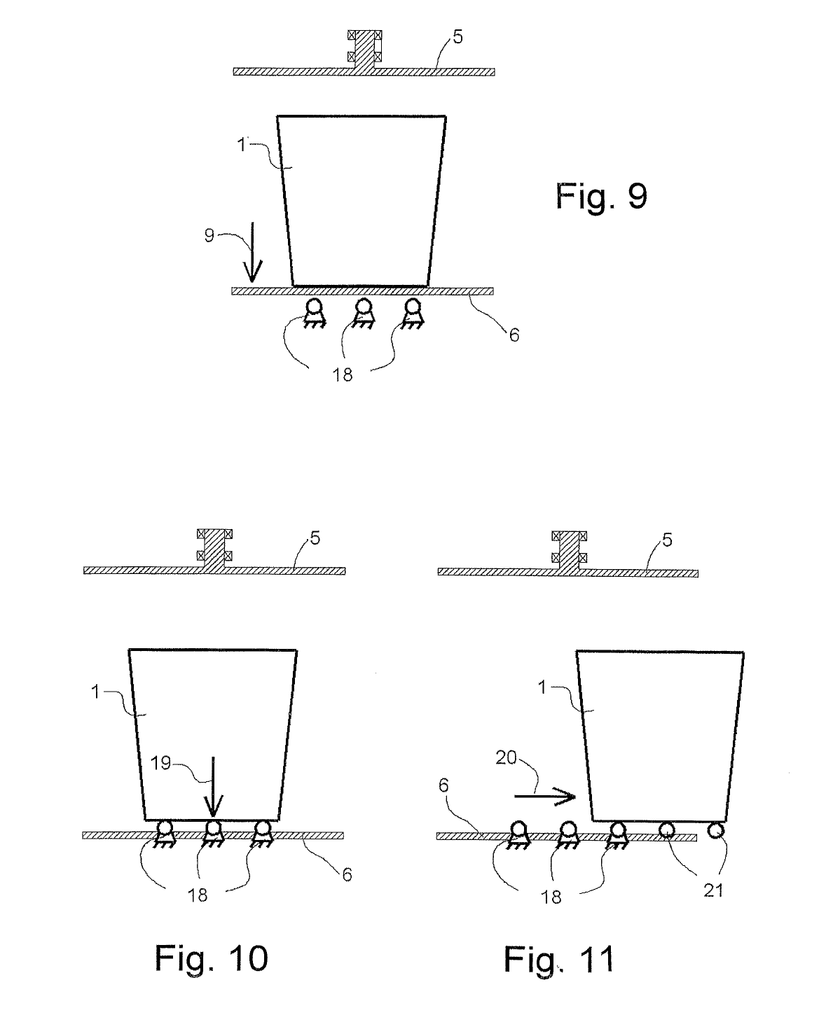

In accordance with FIGS. 9 to 11, a conveyor 18 is arranged at the mixer frame 27 to cooperate with the lower plate 6 and to transfer the paint pot 1, the contents of which have been mixed, away from the mixer in the direction of arrows 19 and 20 illustrating the transfer. The paint pot 1 may be transferred by the conveyor 18 and its potential extension to other process steps of the paint pot 1, or from there to this mixer.

The above mixer operates in the following manner:

A paint pot 1 the contents of which are to be mixed is transferred by suitable means, such as a conveyor 18, from a toning apparatus, for example, in between plates 5 and 6, when the plates 5 and 6 are in a position of FIG. 1 and locked by a connection 11 to the mixer frame 27 in a non-rotating manner with respect to the shaft 2 of the drive wheel 12. After this, the drive is started according to a predetermined programme and it begins to move the plates 5 and 6 towards one another by using the drive wheel 12 and the tightening arms 7 and 8 in connection therewith. In the applications of FIGS. 7 and 8, the plates 5 and 6 are pressed against the paint pot by wheel-chain systems described in connection with these figures and operating by means of the same drive wheel 12. After the plates 5 and 6 have been pressed against the paint pot 1 on its both sides, the tightening continues up to a predetermined torque, after which the ratchet mechanism 13 to 17 and the spring suspensions 22 to 25 keep the paint pot 1 in its place at this torque and do not allow the torque to increase during the subsequent mixing, especially if the actuator 16, 17 of the ratchet mechanism is selected to be bifunctional (FIGS. 2 to 4).

As soon as the above-mentioned tightening of the paint pot in its place has been achieved, the entity consisting of the paint pot 1, the plates 5 and 6 and the tightening arms 7 and 8 (or the wheel-chain system of FIGS. 7 and 8) is released from the connection 11, and the entity starts to be rotated (FIG. 6) about the shaft 2 of the drive wheel 12 by the same drive used for tightening the paint pot in its place at a selected rotating speed, while the drive brings the plates 5 and 6 and the paint pot 1 between them into rotation about their own axes as well. This brings the paint pot 1 and its contents into gyroscopic rotation, whereby the Coriolis force is applied to the paint mass, causing an efficient turbulent mixing, during which the ingredients of the paint are mixed with one another efficiently. When a sufficient degree of mixing has been achieved and the paint pot 1 is to be taken away from the mixer, the entity in rotation is stopped and the connection 11 is locked, after which the pawl 14 is released from the tooth of the ratchet wheel 13, the plates 5 and 6 are brought away from one another by means of the above-mentioned drive by operating it in the opposite direction than in the tightening until the situation is the same as in FIG. 1.

Next, the paint pot 1 may be released to the conveyor 18 according to FIGS. 9 to 11, and simultaneously a new paint pot 1 may be brought by the conveyor 8 to the mixer for mixing.

The above description of the invention is only intended to illustrate the basic idea of the invention. Thus, a person skilled in the art may implement the details of the invention in various ways within the scope of the attached claims.

1-13. (canceled)

14. A mixer for mixing the contents of a paint pot, the mixer comprising:
pressing means for pressing the paint pot in the direction of its longitudinal axis between two support surfaces;
means for rotating the paint pot pressed between these support surfaces about its longitudinal axis; and
a shaft substantially perpendicular to the longitudinal axis;
wherein:
the pressing means and the rotating means are combined to form a mechanism arranged to be operated by one drive;
the support surfaces comprise two plates arranged to move towards one another;
a drive wheel is connected between the plates on a side thereof;
a sheave rotating about a shaft parallel to the shaft of the drive wheel and provided in line with the drive wheel is arranged above or below one plate; and
the drive wheel and the sheave are connected to one another by a chain, a section of the chain between the drive wheel and the sheave and moving in one direction is connected to one plate and a section moving in the other direction is connected to an arm protruding from the other plate for bringing the plates closer to and away from one another, the drive wheel being connected to said common drive.

15. A mixer as claimed claim 14, further comprising a ratchet mechanism arranged at the drive wheel to lock the paint pot in its place between the plates.

16. A mixer as claimed in claim 15, wherein the ratchet mechanism comprises:
a ratchet wheel;
a pawl in connection with a tooth of the ratchet wheel;
a spring keeping the pawl in said connection; and
an actuator affecting the pawl for releasing it from the tooth of the ratchet wheel.

17. A mixer as claimed in claim 16, wherein the actuator is bi-functional to keep the pawl at a desired tooth of the ratchet wheel at a desired tightening torque.

18. A mixer as claimed in claim 16, further comprising a spring suspension arranged between the ratchet wheel, the drive wheel, and the shaft thereof.

19. A mixer as claimed in claim 14, further comprising a spring suspension arranged between the tightening arm and the plate.

20. A mixer as claimed in claim 14, further comprising a spring suspension arranged on the surface of the plate.

21. A mixer as claimed in claim 14, wherein, to provide the rotating means, the pressing means are mounted on bearings to rotate about the shaft of the drive wheel and the plates are mounted on bearings to rotate about their middle axis, whereby, to press the paint pot in its place, rotation of this mechanism about the shaft of the drive wheel is prevented and, to rotate the paint pot, the prevention of rotation is released, and a rotatable entity comprising the pressing means and the rotating means is supported on a frame of the mixer at one point in a line formed by the shaft of the drive wheel.

22. A mixer as claimed in claim 21, further comprising a lockable and releasable connection between the mixer frame and the plate and sliding in the axial direction of the plate, wherein prevention of rotation is implemented by said lockable and releasable connection.

23. A mixer as claimed in claim 21, wherein the rotation of the plates about their middle axis is also implemented by said common drive.

24. A mixer as claimed claim 14, further comprising a conveyor arranged at the mixer frame to cooperate with the lower plate and to transfer the paint pot, the contents of which have been mixed, away from the mixer.

25. A mixer for mixing the contents of a paint pot, the mixer comprising:
pressing means for pressing the paint pot in the direction of its longitudinal axis between two support surfaces;
means for rotating the paint pot pressed between these support surfaces about its longitudinal axis; and
a shaft substantially perpendicular to the longitudinal axis;
wherein:
the pressing means and the rotating means are combined to form a mechanism arranged to be operated by one drive;
the support surfaces comprise two plates arranged to move towards one another;
a drive wheel is connected between the plates on one side thereof;
a sheave rotates about a shaft parallel to the shaft of the drive wheel and provided in line with the drive wheel is arranged above or below one plate;
the drive wheel and the sheave are connected to one another by a chain, and on an opposite side of an entity including the drive wheel, the sheave, and the chain, there is arranged an entity substantially identical and symmetrical with said entity including the drive wheel, the sheave, and the chain, said substantially identical entity in turn comprising:
an auxiliary drive wheel in the same axial line with the sheave,
an auxiliary sheave, and
an additional chain connecting them,
the sheave and the auxiliary drive wheel being connected to one another by a connecting shaft, whereby the plates are provided with transverse arms, the ends of one arm being connected to chain sections moving in one direction and the ends of the other arm being connected to chain sections moving in the other direction for bringing the plates closer to and away from one another, the drive wheel being connected to said common drive.

26. A mixer as claimed in claim 25, wherein said auxiliary sheave is in the same axial line with the drive wheel.

27. A mixer as claimed claim 25, further comprising a ratchet mechanism arranged at the drive wheel to lock the paint pot in its place between the plates.

28. A mixer as claimed in claim 27, wherein the ratchet mechanism comprises:
a ratchet wheel;
a pawl in connection with a tooth of the ratchet wheel;
a spring keeping the pawl in said connection; and
an actuator affecting the pawl for releasing it from the tooth of the ratchet wheel.

29. A mixer as claimed in claim 28, wherein the actuator is bi-functional to keep the pawl at a desired tooth of the ratchet wheel at a desired tightening torque.

30. A mixer as claimed in claim 28, further comprising a spring suspension arranged between the ratchet wheel, the drive wheel, and the shaft thereof.

31. A mixer as claimed in claim 25, further comprising a spring suspension arranged between the tightening arm and the plate.

32. A mixer as claimed in claim 25, further comprising a spring suspension arranged on the surface of the plate.

33. A mixer as claimed in claim 25, wherein, to provide the rotating means, an entity comprising the pressing means is mounted on bearings to rotate about the shaft of the drive wheel and the plates are mounted on bearings to rotate about their middle axis, whereby, to press the paint pot in its place, rotation of this mechanism about the shaft of the drive wheel is prevented and, to rotate the paint pot, the prevention of rotation is released, and wherein a rotatable mechanism comprising the pressing means and the rotating means is supported on the mixer frame at two supporting points, which are on the opposite side of the mechanism and provided in the line formed by the shaft of the drive wheel and a shaft of the auxiliary sheave.
